(19) United States
(12) Patent Application Publication
(10) Pub. No.: US 2020/0167494 A1
(43) Pub. Date: May 28, 2020

(54) Binder and Literature Exchange Network

(71) Applicant: Tributary Publishing, Inc., Las Vegas, NV (US)

(72) Inventors: Nissim Ozer, Las Vegas, NV (US); Olga Gonzalez, Las Vegas, NV (US); Ryhor Pradun, Minsk (BY)

(21) Appl. No.: 16/698,915

(22) Filed: Nov. 27, 2019

Related U.S. Application Data
(60) Provisional application No. 62/772,478, filed on Nov. 28, 2018.

(51) Int. Cl. G06F 21/62; G06F 16/176; G06Q 30/02; G06Q 30/06

(52) U.S. Cl. CPC G06F 21/6218; G06Q 30/0633; G06Q 30/0283; G06F 16/176

(57) ABSTRACT

A data exchange network in which user created files can contain user data and source data, user created files can be shared, and access to data within user created files can be controlled. The systems and techniques feature enabling a computing device network to output, input, store, and control access data as whole files and as distinct parts within user created files. The systems and techniques also feature enabling a computing device to access data within a user created media file with various levels of access restrictions.

### CROSS-REFERENCE TO RELATED APPLICATION

This application claims the benefit of U.S. Provisional Application No. 67/772,478, filed Nov. 28, 2018.

### TECHNICAL FIELD

This application relates to a data exchange network in which user content can be shared and source content access can be controlled within a user created file.

### BACKGROUND

Data and its transfer are an ever present and increasingly growing aspect of modern life. Common tasks in education, the workforce, and the home are continuously replacing the pen and paper with digital equivalents. Sharing this data, however, has its own separate hurdles such as cybersecurity, privacy, decentralization, and a variety of technical and legal restrictions.

For example, a graduate physics student may create valuable notes during his undergraduate courses on a computer. The notebook file contains copied literature material parallel to the graduate student's annotations and work product. The notebook, a combination of the student's own writing and others' copyrighted material, has immediate value to aspiring undergraduate students and the graduate student wishes to exploit the notebook's value. Unfortunately, the graduate student has limited options. Selling the notebook as is may violate copyright laws, despite the original material provided by the graduate student. Additionally, graduate student will desire an established sharing network to maximize his notebook's demand. Other limitations in terms of cybersecurity, privacy, and technical and legal difficulties may prevent others from accessing the material.

In another example, a business may wish to market a new product. The business may further wish to better evaluate demand by a marketing campaign that encourages user engagement and interaction. Consumer driven advertisement campaigns, otherwise known as viral marketing, can advantageously reach more consumers. Unfortunately, viral marketing also has numerous challenges including cybersecurity, privacy, technical, legal, and actual measurement.

Existing methods of clearing these hurdles require extensive manual clearance procedures and cumbersome technological methods such as digital rights management, contract management, and other large-scale data management systems that scale at great cost and technical difficulty. Even still, these systems are subject to security and privacy limitations. Thus, there is a strong need for a system that overcomes these limitations.

### SUMMARY

This system and method relate to a data exchange network in which user content can be shared and source content access can be controlled within a user created file.

In one aspect, the systems and techniques disclosed here feature a system configured to enable a computing device network to output, input, store, and control access to source data as individual files and as within user created media binder files and to output, input, and store user created data as independent files and as within user created binder media file data to and from a computing device connected via a network interface.

In one implementation, there is at least one server, comprising a processor, a memory, a network interface, and a hard drive. The server can store and execute a media platform program to enable a computing device connected via a network interface to create a user created binder media file data, in which said media platform can receive requests, inputs, and outputs from the computing device to create a user created media binder file that can comprise source data and/or user inputted data. The server can also store source data, user data, and user created binder media files for use on the server. The server can also receive access requests from a computing device to access source data, as is or as within a user created media binder file, and output source data to the requesting computing device after a successful verification process for access to the source data. The server can execute a program that runs an access value for a source data against an access value of the computing device for the source data in question. The server can output an access grant to the computing device that sent a source data access request after a successful verification, or alternatively the server can output an access denial to the storage server for the computing device that sent a source data access request after an unsuccessful verification.

This implementation may include one or more of the following features.

For example, a database within the server for organizing user computing device access to source data. The database can maintain a constant instance for source identification data and user identification data for a given category and can be scalable using a master-slave replication.

Another feature may be a computer program stored on and executed by the server for organizing and verifying a user computing device's access to source data. The computer program can record user identification and binder identification together as a record within a constant entity within a database. The computer program can record binder purchases by recording user identification and binder identification together as a record within a constant purchaser entity within a database. The computer program can also record binder shares, permissions, and co-authorships between users by recording user identification and binder identification together as a record within a constant share permission entity within a database.

The computer program may retrieve author identifications associated with the user identification as stored on the server, retrieve edit permissions identifications associated with the user identification as stored on the server, retrieve purchased source data identification associated with the user identification as stored on the server, and create an array of source data identification comprising from the author identification, edit permissions identification, and source data purchases associated with the user identification as stored on the server. The computer program can display the source data in question on the user computing device if the identification of the source data in question matches one of the source data identifications from the array. The computer program can also display a message indicating the source data in question cannot be accessed by the user if the identification of the source data in question does not match one of the source data identifications from the array.

Another feature may be a computer program that can store at least one unique hash key for a source data on the server, encode source data as used within a binder media file with the hash key, and record user identification and the hash key together as a record within a constant entity within a database. The computer program can decode a source data by retrieving a source data hash key when a user identification is found recorded together with a hash key. The computer program can also leave a source data encoded when a user identification is not found recorded together with a hash key.

Another feature may be a computer program that can offer access to the source data to a computing device that has been denied access to source data access to the source data. The computer program can create a list of the source data the computing device attempted to access and was denied access to, output the list of the source data to a transaction server, receive, from the transaction server, an updated list of the source data including pricing information to purchase a license to the source data, and output the updated list of the source data to the computing device.

Another feature may be a computer program that can assess all source data that a computing device does not have access to, offer access to all source data the computing devices does not have access to, offer access to individual source data the computing devices does not have access to, and have all access offers be sent promptly after an access denial.

Another feature may be a computer program that can output, to a connected computing device that outputs a new source data to the storage server, an access approval agreement that allows a user of the connected computing device to select from amongst multiple access verification values for the new source data to be sent to the storage server.

Another feature may be a computer program that can output, to a connected computing device that outputs a new user created media file to the storage server, an access approval agreement that allows a user of the connected computing device to select a from amongst multiple access verification values for user inputted data within the user created media file.

Another feature may be an operating system stored on and executed by the server for an online marketing system. The operating system can provide a marketing platform for seller users to input an information within a marketing media file and input an access value for an information as controlled information data within a marketing media file. The operating system can also enable consumer users to display a marketing media file via a computing device connected via a network interface. The operating system can enable consumer users to interact with a marketing media file and access the controlled information data by acquiring access.

In another aspect, the systems and techniques disclosed here feature a method for a computing device network to store and sell literature from an online market place, enable a computing device connected via a network interface to create, share, and sell binder media files comprising of literature data, user data from another file, and user inputted data, and control access to the literature data within the binder media file from the or another computing device connected via a network interface.

In one implementation, the systems and techniques can include a method for storing literature and user data within the network, including literature data files, user created data files, and binder media files. The method can also include sending source data, user data, and binder media data to a computing device connected via a network interface. This can include displaying an account page comprising data files the computing device has access to such as published books, scholarly articles, user created files, and binder media files, displaying an online marketplace for the computing device to access literature data, user created data, and binder media data, displaying literature data in a readable format by the computing device, displaying user data in a readable format by the computing device, displaying binder media data in a readable format by the computing device, and displaying quoted or linked literature data, user created data, or binder media data within a binder media file sourced back to the respective data file. The method can further include enabling a computing device connected via a network interface to interact with literature data, user data, and binder media data, create user data files, and create binder media files. This can include enabling interaction with literature data by the computing device such as sending literature data to a binder media file, creating a link to literature data, and adding notes to literature data, enabling interaction with user data by the computing device such as sending user data to a binder media file, creating a link to user data, and adding notes to user data, enabling interaction with binder media data such as sending binder media data to a binder media file, creating a link to binder media data, adding notes to binder media, and accepting data links to purchase access to literature data, user data, or binder media data within a binder medial file, and enabling creation of user files and/or binder media files by the computing device wherein text and/or other media can be inputted within an interactive text box and/or literature data, user created data, and/or binder media data can be quoted and/or linked within an interactive text box. The method can also include controlling the access of a computing device connected via a network interface to literature data, user data, and binder media data. This includes receiving requests to access literature data, user data, and/or binder media data from the computing device, receiving user data and user created binder media file data from the computing device, outputting source, user data, and user created binder media file data to the computing device, verifying the computing device has the requisite access to a specific source data upon a request from the computing device to access the source data in question, granting access to the source data in question if a computing device has the requisite access to a specific source data upon request, and denying access to the source data in question if a computing device does not have the requisite access to a specific source data upon request.

This implementation may include one or more of the following features.

For example, a method enabling a computing device network to provide a computing device connected via a network interface a method to publish, share, price, and sell binder media files over the computing device network. The method can include adding book text quotes to a binder by opening a book in a viewing mode, highlighting text, and executing a command to send the highlighted text to a binder media file, enabling a user share, edit, and co-author a binder media file with other users by giving permission to other users, publishing and selling a binder media file over the computer network, setting a price for a binder media file using criteria comprising of factors of the binder media file and derivative source data, purchase source data files from the computing device network market place, purchasing binder media files with all associated source data within, purchasing binder media files without any associated source data within, and purchasing binder media files and specific source data within.

Another feature may be a method enabling a computing device network to control access to source data stored on the network. The method can include checking if a user is an author of a source data, checking if a user is a co-author or has editing or share permissions of a source data, checking if a user is a purchaser of a source data, enabling a user that has at least passed one of the checks to access the source data, and preventing a user that does not pass any one of the checks from accessing the source data.

Another feature may be a method enabling a computing device network to control access to source data stored on the network. The method may include associating at least one unique key to a source data, encoding a source data with the unique key, giving the key to users to decode the source data with the unique key.

Another feature may be a method enabling a computing device network to offer access to source data to a computing device that has been denied access to source data access to the source data. The method may include creating a list of the source data the computing device attempted to access and was denied access to, outputting the list of the source data to a transaction server, receiving, from the transaction server, an updated list of the source data including pricing information to purchase a license to the source data, and outputting the updated list of the source data to the computing device.

Another feature may be a method enabling a computing device network to assess all source data that a computing device does not have access to, offer access to all source data the computing devices does not have access to, offer access to individual source data the computing devices does not have access to, and have all access offers be sent promptly after an access denial.

Another feature may be a method enabling a computing device network to output, to a connected computing device that outputs a new source data to the storage server, an access approval agreement that allows a user of the connected computing device to select from amongst multiple access verification values for the new source data to be sent to the storage server.

Another feature may be a method enabling a computing device network to output, to a connected computing device that outputs a new user created media file to the storage server, an access approval agreement that allows a user of the connected computing device to select a from amongst multiple access verification values for user inputted data within the user created media file.

Another feature may be a method enabling a computing device network to provide a marketing platform to seller users and consumer users using computing devices connected via a network interface. The method may include providing a marketing platform for seller users to input information for display and/or consumption to consumer users as a marketing media file, enabling seller users to control access to an information within a marketing media file, enabling consumer users to view a marketing media file, enabling consumer users to interact with a marketing media file, and enabling consumer users to access the controlled information by acquiring access.

### DESCRIPTION OF DRAWINGS

FIG. 1 is a block diagram of an example system for a binder and literature exchange network.

FIG. 2 is a block diagram of an example user created binder media file comprising selected source material data and user inputted data.

FIG. 3 is an example high-level overview block diagram of one embodiment of a system for a binder and literature exchange network.

FIG. 4 illustrates a user authentication for accessing source material data carried out by a server according to one embodiment.

FIG. 5 illustrates one embodiment of a server displaying an encoded binder media file.

FIG. 6 illustrates one embodiment of a server rendering a binder and verifying user access to source material data.

FIG. 7 is a swim-lane diagram of an example binder media file with selected source material data and user inputted data created by one user, shared with a second user, and verified for an access value from the second user.

FIG. 8 is a detailed view of an example computing device that can be used within the binder and literature exchange network.

FIG. 9 is a block diagram of an example user access controlled viral marketing campaign.

### DETAILED DESCRIPTION OF THE DRAWINGS

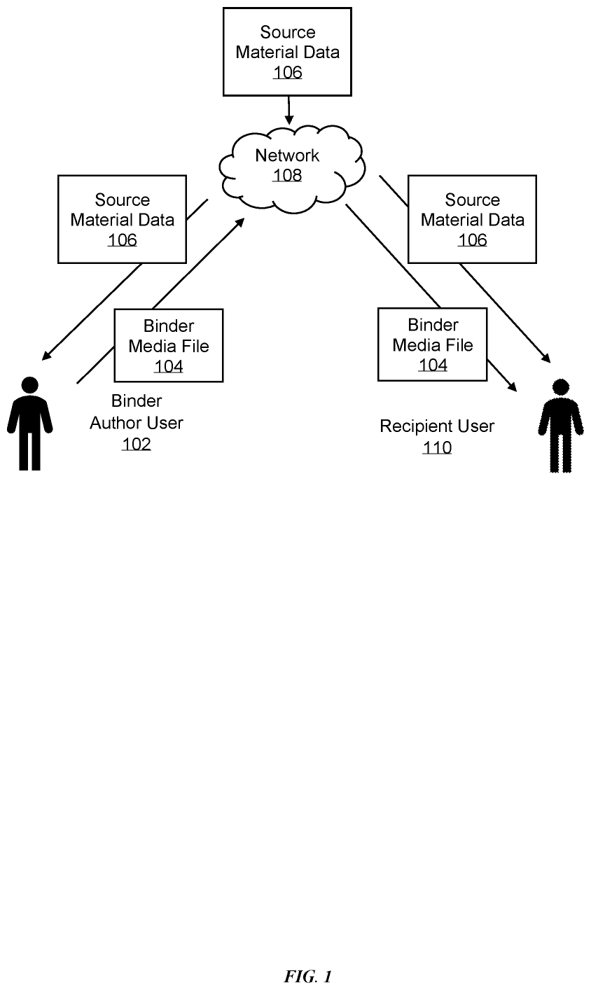

FIG. 1 is a block diagram of an example system for a binder and literature exchange network. Using the system, a binder author user 102 via a computing device can access source material data 106 stored on a computing device network 108. Binder author user 102 can also create and store binder media files 104 using source material data 106 and/or his own user inputted data on the network. Other users such as a recipient user 110 can access material such as the source material data 106 and the binder media file 104 stored on the network 108. The system can include one or more systems with which users can interact with.

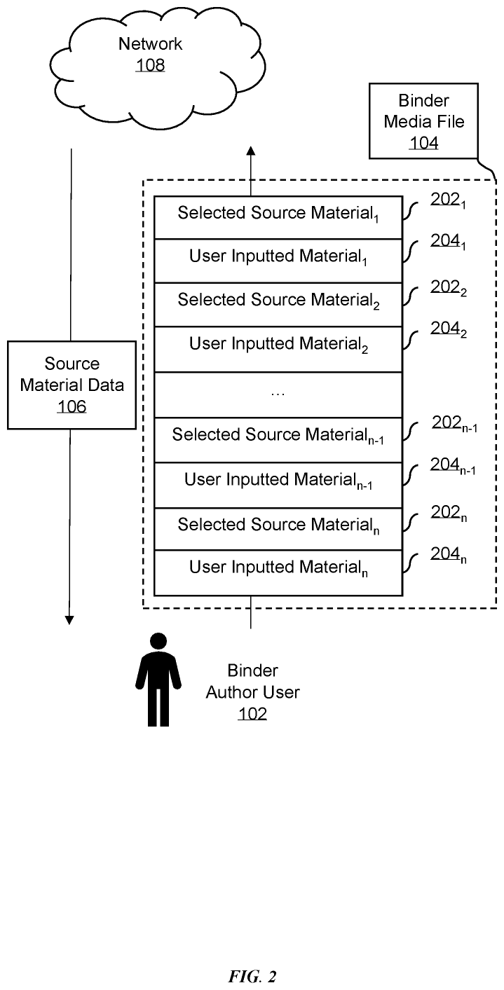

FIG. 2 is a block diagram of an example user created binder media file 104 comprising selected source material data 202 from source material data 106 and binder author user inputted material data 204. A binder author user 102 accesses a source material data 106 via a network 108. Using a media platform provided by the network 108, the binder author user 102 can create a binder media file 104. The binder media file 104 in this example demonstrates alternating input of selected source material data 202 and binder author user inputted material data 204. The binder author user 102 can further send the binder media file 104 from his location to a server storage via the network 108.

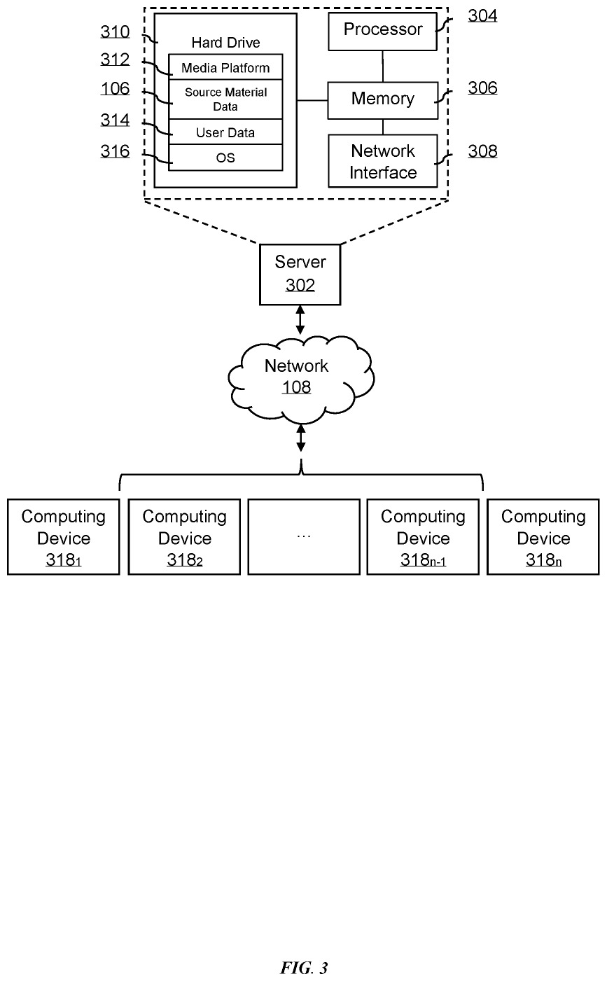

FIG. 3 is an example high-level overview block diagram of the example system for a binder and literature exchange network from FIG. 1. As shown, FIG. 3 demonstrates how different components of the system can be configured to implement the various techniques described herein. Within network, there can be a server 302 which can include a processor 304, a memory 306, a network interface 308, a hard drive 310. The hard drive 310 can further include within its contents a media platform 312, source material data 106, user data 314, and an operating system (“OS”) 316. An at least one computing device 318 provides an input method for users to utilize the system provided by server 302. The computing device interfaces with the sever 302 connected via network interface 308. The media platform 312 provides users with an interface usable via a computing device 318 as shown in FIG. 2 to display and interact with source material data 106, input user inputter material 204, and create and upload binder media files 104. User data 314 can include user inputted material 204, binder media files 104, and other data such as user identification information. OS 316 can include a computer program for carrying out function of server 302.

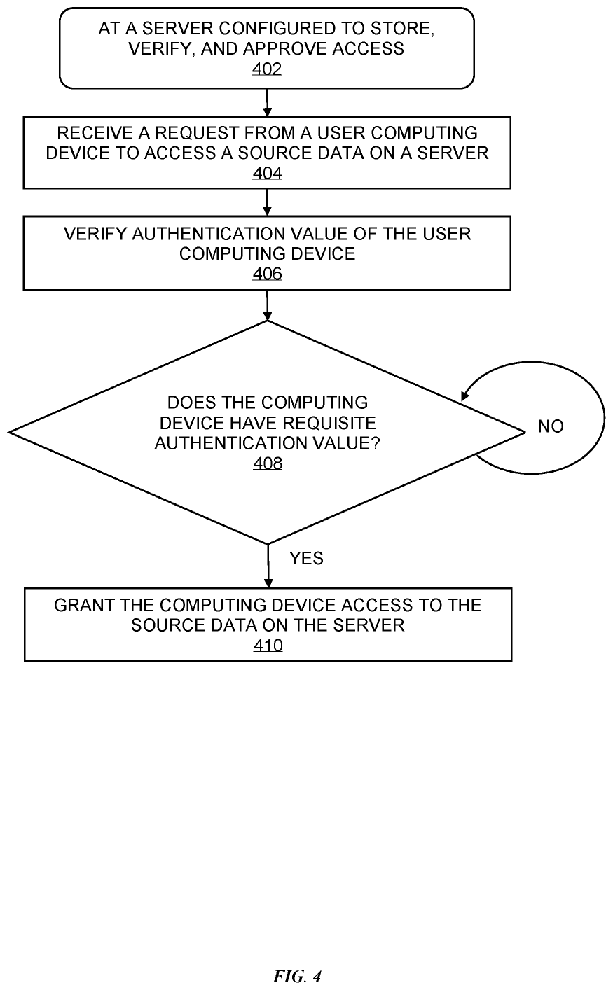

FIG. 4 illustrates a user authentication for accessing source material data 106 carried out by a server 302 according to one embodiment. At step 1 402, the server 302 is configured to according to one embodiment. At step 2 404, the server 302 may receive a request from a user computing device 318 when, for example, the user computing device 318 attempts to access source material data 106 stored on server 302 via a binder media file 104 created by a binder author user 102. Computing devices 318 can attempt to access source material data 106 by sending an access request to transaction server. At step 3 406, the server 302 can verify the access value of the computing device 318 for the requested source material data 106. At step 4 408, the server 302 determines if user computing device 318 has the requisite access value. If the resulting determination is negative, the server 302 can, in one embodiment, offer the user computing device 318 steps to acquire the requisite access value. In another embodiment, the server 302 can deny access and briefly describe the source material data 106. If the resulting determination is positive, the method moves on to Step 5 410 and the server 302 grants the user computing device 318 access to the source material data 106 held within the server 302.

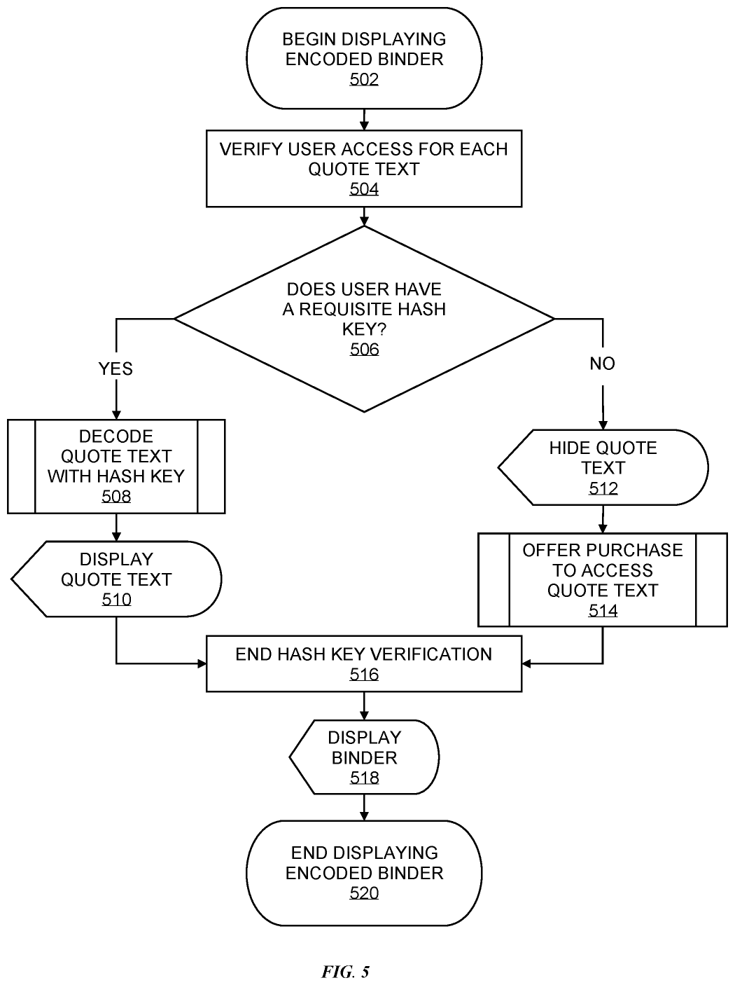

FIG. 5 illustrates one embodiment of a server 302 displaying an encoded binder media file 104. First, the server begins displaying the encoded binder 502. Next, the server verifies a user computing device's user access for each quote text 504. The server then checks a user's possession of a requisite hash key for each quoted text within the binder 506. If the user does possess the requisite hash key, the server then goes through the process of decoding the quote text with the hash key 508. The quote text is then displayed via the user computing device 510. If the user does not possess the requisite hash key, the quote text is hidden 512. This can be in the form of a message displayed on the user computing device indicating the user does not have the requisite access to the quote text in question. The server can subsequently perform a process to display a method on the user computing device to obtain access to the quote text in question 514. For example, the server can send a hyperlink to the user computing device to purchase a book or a chapter with the text in question. The server continues the hash key verification process for all quote text material. The binder media file 104 is displayed with quote text displayed or hidden 518 and the encoded binder finishes 520.

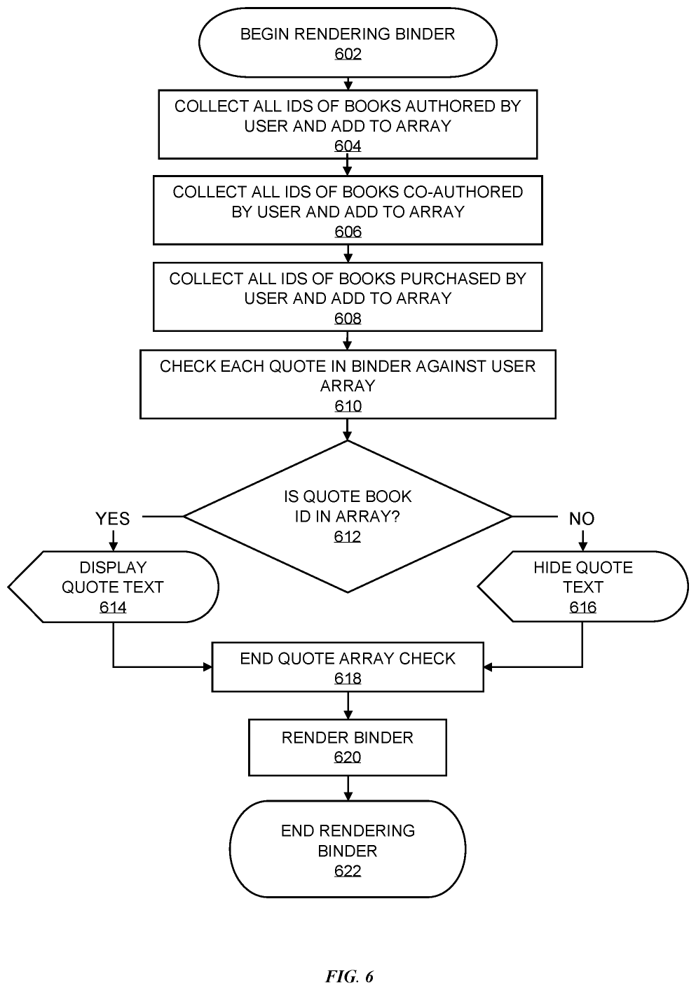

FIG. 6 illustrates one embodiment of a server rendering a binder and verifying user access to source material data 106. The server begins rendering a binder 602. Next, the server 302 collects the identification information, for example a BOOK ID Number, of all books authored by a user and adds this identification information to an array specified to the user 604. The server 302 then collects the identification information of all books co-authored by the user and adds this identification information to the array 606. The server 302 then collects the identification information of all books purchased by the user and adds this information to the array 608. The array containing the identification information of the books a user has authored, co-authored, and purchased is compared against the identification information of each book quote in a binder 610. If the book identification information for a quote is matched with the information in the array, the quote book text is displayed 614. If the book identification information for a quote is not matched with the information in the array, the quote book text is hidden. The server 302 repeats comparing the user identification array against each book quote within a binder. After completing the quotation array check 618, the server renders the binder with all quote book text displayed or hidden 620. Please see Appendix A for example code of how a user array is created, including retrieving authorship identification information, edit privilege information, and purchased book information.

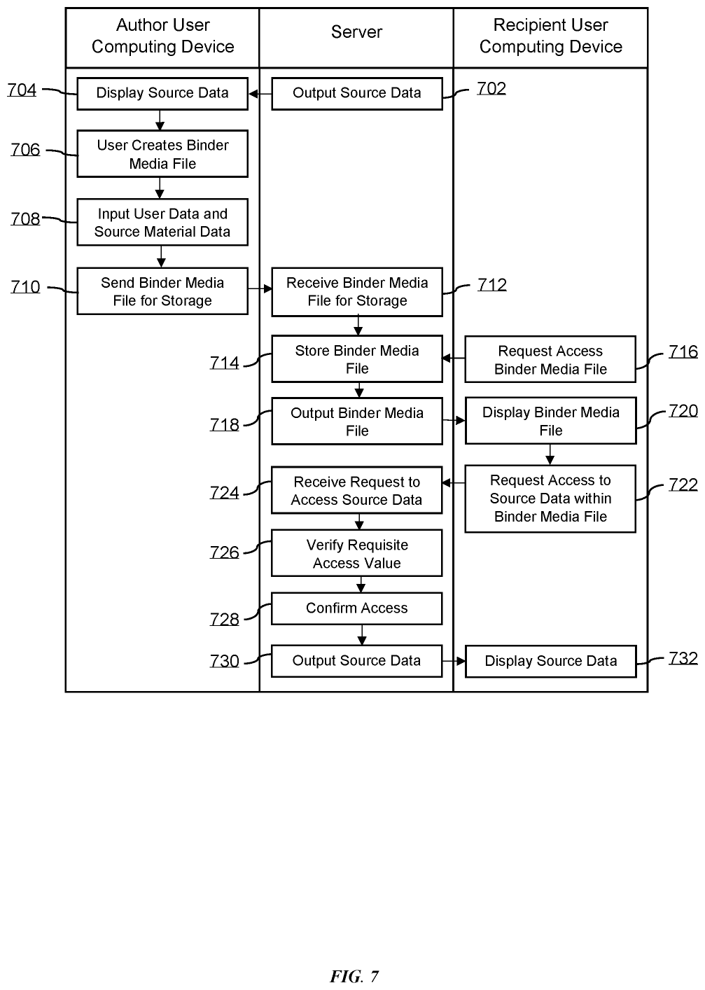

FIG. 7 illustrates a swim-lane diagram of an example user created binder media file 104 being shared between two user computing devices 318 and a server 302. A first binder author user computing device 318 can interface with a network 108 provided by the server 302. The server 302 outputs source material data 702 to the first user computing device 318 and the source material data 106 is displayed 704 on the first user computing device 318. An author user creates a binder media file 706 inputting user inputted data and user selected source material data 708. The binder media file is sent to the server 710, received by the server 712, and stored on the server 714 for access by the author user or other users.

A recipient user using a second computing device can access the binder media file 104. The second computing devices requests 716 access to the binder media file 104 stored on the server. The server outputs the binder media file 718 to the second computing device, and the second computing device displays the binder media file 720. The second computing device subsequently requests access to source material data within the binder media file 722, for example attempting to view quoted material from an individual book within the binder file. The server receives the second computing device's request to access the source data 724. The server then verifies the recipient user's access permission to the source data 726. For example, the server can verify the recipient user's possession of a requisite hash key as described in FIG. 5. In another example, the server can verify the recipient user's access permissions by creating a BOOK ID Number array as described in FIG. 6. After the server verifies recipient user's access to the source material data 728, the server outputs the source material data to the second computing device 730. The source material data is then displayed on the second computing device 732. Alternatively, access to the source data can be denied by the server and the source data is blocked for the recipient user using the second computing device as demonstrated in FIGS. 5 and 6. A message indicating the content being blocked can be sent from the server and displayed on the second computing device. Another message indicating how to access the source data, for example offering purchase of a book from which the source data originates, can be sent from the server and displayed on the second computing device.

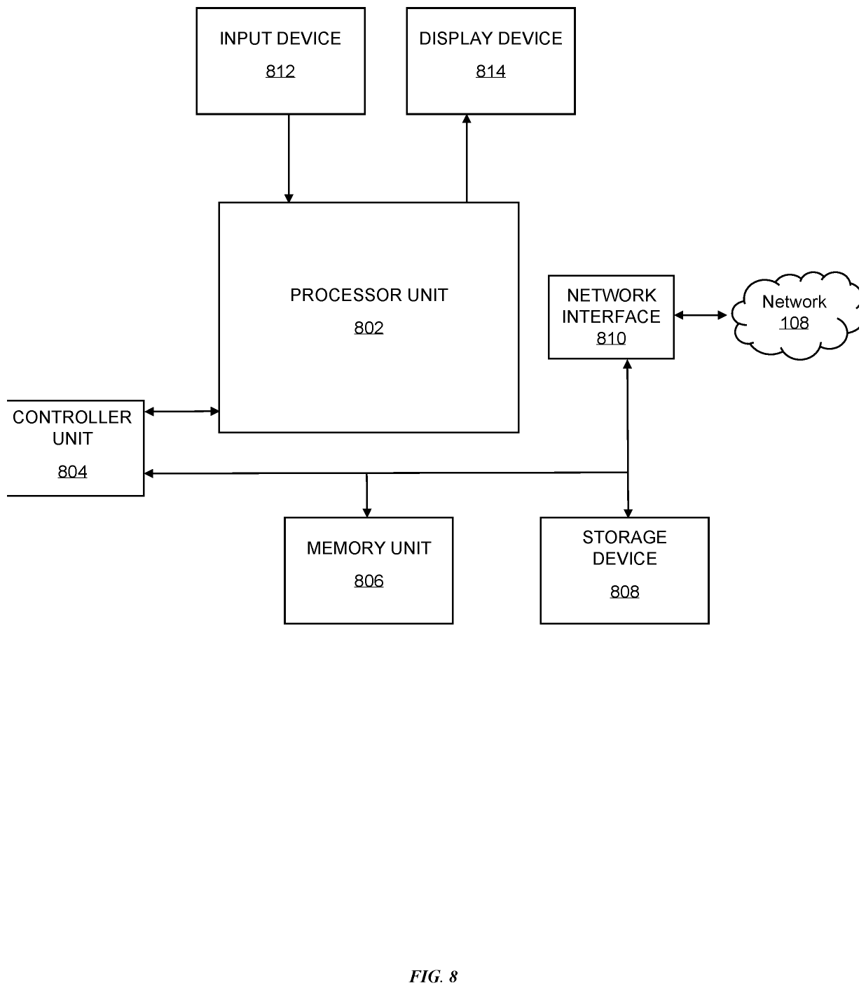

FIG. 8 illustrates a detailed view of an example computing device that can be used with the binder and literature exchange network. The detailed view shows various components that can be included in a user computing device or a server as illustrated in FIG. 3. A computing device is intended to represent various forms of digital computers, such as laptops, desktops, workstations, personal digital assistants, cellular phones, smartphones, tablets, servers, blade servers, mainframes, and other appropriate devices. The components shown here, their connections and relationships, and their functions are meant to be exemplary only.

An example computing device can include a processor unit 802, a controller unit 804, a memory unit 806, a storage device 808, a network interface 810, an input device 812, and a display device 814. Each of the components are interconnected via various busses and can be mounted on a motherboard or other appropriate variants. The processor unit 802 can control the overall operation of the computing device. The processor unit 802 can process instructions for execution within the computing device including instructions from the memory unit 806 or the storage device 808. The controller unit 804 can manage instructions between the processor unit 802 and other hardware devices such as the memory unit 806, the storage device 808, and the network interface 810.

The memory unit 806 can store information for use by the computing device. One implementation of the memory is a volatile memory unit or units which can store instructions related to the operation of the computing device (e.g., Random Access Memory). Another implementation of the memory unit 806 is a non-volatile memory unit which can store programs, utilities, or processes to be executed in a non-volatile manner (e.g., Read-Only Memory).

The storage device 808 can provide mass storage for the computing device. The storage device can be or may contain a computer readable medium (e.g., a floppy disk drive, a hard disk device, an optical disk device, a tape device, or a similar device), a flash memory or a similar solid-state memory device, or an array of configured devices such as a storage area network. The storage device 808 can have a storage management module that manages one or more partitions within the storage device 808.

The network interface 810 can couple to a data link between the computing device and the network 108. The network interface 810 can include a wireless transceiver. The input device 812 can be a means for a user to interact with the computing device. An input device 812 can include a button, keypad, dial, touch screen, audio input interface, image capture input interface, a sensor, and other similar devices. The display device 814 can be a device the processor 802 controls to display visual information and can include computer monitors, smart phone screens, tablet screens, and other similar devices.

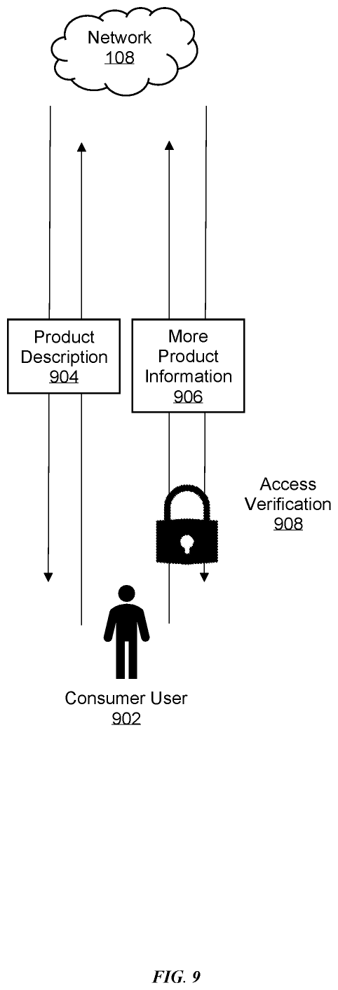

FIG. 9 is a block diagram of an example implementation of the binder and notebook sharing network, a user access controlled viral marketing campaign. A network 108 provides the material and access points for a consumer user 902. The consumer user 902 can access and display a product description 904. If the consumer user 902 wishers to examine a product further, the consumer user 902 can access more product information 906. However, a marketer can hide the more product information 906 behind an access verification 908. For example, the consumer user 902 can obtain a password, hash key, or other instrument to pass the access verification 908.

```
APPENDIX A
namespace app\models\contentFields;
use app\models\contentFields\BaseContentField;
use app\models\CasebookContent;
use app\helpers\ContentTypeHelper;
use app\models\ContentType;
use app\models\CasebookProfessor;
use app\models\CasebookContentUserCache;
use Yii;
class LinkedContentField extends BaseContentField
{
  public function getForPreview($defaultText = null)
  {
    $userDocs = (Yii::$app->getUser( )->isGuest)?[ ]:Yii::$app->user->getIdentity( )-
>getAllUserBookIds( );
    $allowContent = $highlight && in_array($highlight->casebook_id, $userDocs);
    $uid = Yii::$app->getUser( )->getId( );
    $object = ContentType::findWithDeleted( )->where([‘id’ => $highlight->casebook_id])-
>one( );
    $object = ContentTypeHelper::applyContentTypeClass($object, $object-
>getContentType( ));
    $isNotEmptyCasebook = is_object($object) && !$object->isDeleted( );
    $isYourObject = $isNotEmptyCasebook && $uid == $object->author_id;
    if (!$allowContent) {
      $this->setAsChanged( );
    }
    return Yii::$app->view->render(‘@app/themes/main/content-type/binder_section_view’, [
      ‘highlight’ => $highlight,
      ‘allowContent’ => $allowContent,
      ‘object’ => $object,
      ‘defaultText’ => $defaultText,
      ‘isYourObject’ => $isYourObject,
      ‘isNotEmptyCasebook’ => $isNotEmptyCasebook
    ]);
  }
}
public function getAllUserBookIds($isProfessorsBooks = false)
{
  if (!empty($this->userBookIds[‘casebooks’])) {
    return $this->userBookIds[‘casebooks’];
  }
  $this->userBookIds[‘casebooks’] = Share::find( )->select(‘content_type_id’)->where([‘user_id’
=> $this->id])->column( );
  $this->userBookIds[‘casebooks’] = ArrayHelper::merge(
                    $this->userBookIds[‘casebooks’],
                    ContentType::find( )->select(‘id’)->where([‘author_id’ => $this->id])-
>column( ),
                    ContentTypeUser::find( )->select(‘content_type_id’)->where([‘user_id’
=> $this->id, ‘status’ => ContentTypeUser::STATUS_PURCHASED])->column( )
                  );
  return $this->userBookIds[‘casebooks’];
}
```

1. A system configured to enable a computing device network to output, input, store, and control access to a multitude of source data as individual files and within a user created media notebook file, comprising:
at least one data server, comprising a processor, a memory, and a hard drive, wherein the at least one data server is configured to:
store and execute a media platform program to enable a computing device connected via a network interface to create user created notebook media file, in which the media platform can receive requests, inputs, and outputs from the computing device to create the user created media notebook file comprised of the source data and/or the user inputted data;
store the source data;
store the user data;
store the user created notebook media file data;
receive an access request to access the source data, the user data, and/or the user created notebook media file data from the computing device; and
output the source data, the user data, and/or the user created notebook media file data to the computing device; and
at least one transaction server, comprising a processor, a memory, and a hard drive,
wherein the at least one transaction server is configured to:
receive a verification request from the at least one data server regarding the access request;
output an access grant to the at least one data server regarding the access request; and
output an access denial to the at least one data server regarding the access request.

2. The system of claim 1, wherein:
the computing device network is configured to:
receive the verification request from the at least one data server regarding the access request;
execute a program that runs an access value verification of the source data, the user data, and/or the user created notebook media file data against an access value for the source data, the user data, and/or the user created notebook media file data from the access request;
output the access grant to the at least one data server for the access request after a successful verification granting access to the source data, the user data, and/or the user created notebook media file data to the computing device; and
output the access denial to the at least one data server for the access request after an unsuccessful verification denying access to the source data, the user data, and/or the user created notebook media file data to the computing device.

3. The system of claim 2, wherein:
the computing device network is configured to:
execute, in conjunction with the access denial to the computing device, a data access offer to the computing device to access the source data, the user data, and/or the user created notebook media file data the computing device is attempting to access and has been denied access, the data access offer comprising:
an array of the source data, the user data, and/or the user created notebook media file data the computing device is attempting to access and cannot access; and
the array further including values for pricing information for access to the source data, the user data, and/or the user created notebook media file data the computing device is attempting to access and has been denied access.

4. The of system of claim 2, wherein:
the data access offer is configured to:
assess the source data, the user data, and/or the user created notebook media file data the computing device is attempting to access and has been denied access to after the unsuccessful verification;
be sent promptly after the unsuccessful verification; and
offer access to the source data, the user data, and/or the user created notebook media file data the computing device is attempting to access and has been denied access to after the unsuccessful verification.

5. The of system of claim 2, wherein:
the data access offer is configured to:
assess the source data, the user data, and/or the user created notebook media file data the computing device is attempting to access and has been denied access to after the unsuccessful verification;
be sent promptly after the unsuccessful verification; and
offer access to all the source data, the user data, and/or the user created notebook media file data the computing device is attempting to access and has been denied access to after the unsuccessful verification.

6. The system of claim 2, wherein:
the computing device network is configured to:
output, to the computing device after the computing device outputs the user data and/or the user created notebook media file data to the data server, an access approval agreement that allows the computing device to select from amongst a multitude of access verification values for the user data and/or the user created notebook media file data outputted to the data server.

7. A method for a computing device network to output, input, store, and control access to source data and user data as individual files and as within user created media notebook files, comprising:
providing a media platform that can receive requests, inputs, and outputs from a computing device connected via a network and can enable the computing device to create the user created notebook media file data that can comprise the source data and/or the user data;
storing data within the computing device network including:
storing source data;
storing user data;
storing user created notebook media file data; and
displaying the source data, the user data, and/or the user created notebook media file data to the computing device connected via a network interface.

8. The method of claim 7, further comprising:
controlling and granting access to the source data, the user data, and/or the user created notebook media file data to the computing device connected via the computing device network, comprising:
receiving requests to access the source data, the user data, and/or the user created notebook media file data;
receiving the user data and the user created notebook media file data from the computing device;
outputting the source data, the user data, and/or the user created notebook media file data to the computing device;
verifying the computing device has requisite access to the source data, the user data, and/or the user created notebook media file data;
granting access to the source data, the user data, and/or the user created notebook media file data if the computing device has the requisite access to the source data, the user data, and/or the user created notebook media file data; and
denying access to the source data, the user data, and/or the user created notebook media file data if the computing device does not have the requisite access to the source data, the user data, and/or the user created notebook media file data.

9. The method of claim 8, further comprising:
offering to the computing device that has been denied access to the source data, the user data, and/or the user created notebook media file data, the requisite access to the source data, the user data, and/or the user created notebook media file data, comprising:
creating a list of the source data, the user data, and/or the user created notebook media file data the computing device was denied access to;
updating the list with pricing information to purchase the requisite access to the source data, the user data, and/or the user created notebook media file data from the list;
outputting an access offer to purchase the requisite access to all or some of the source data, the user data, and/or the user created notebook media file data from the list.

10. The method of claim 8, further comprising:
delivering, to the computing device after the computing device outputs the user data and/or the user created notebook media file data to the data server, an access approval agreement that allows the computing device to select from amongst a multitude of access verification values for the user data and/or the user created notebook media file data outputted to the data server.
